(19) United States
(12) Patent Application Publication
(10) Pub. No.: US 2007/0227362 A1
(43) Pub. Date: Oct. 4, 2007

(54) Portable linear air cleaning system

(76) Inventor: Nick Charles Parker, Lubbock, TX (US)

Correspondence Address: Dr. Nick C. Parker, 7805 Zoar Avenue, Lubbock, TX, 79424, US

(21) Appl. No.: 11/396,030

(22) Filed: Apr. 3, 2006

(51) Int. Cl. B01D 46/00

(52) U.S. Cl. 96/224

(57) ABSTRACT

A new and improved portable and maneuverable invention for the purification of quantity of air within a commercial or residential room. Said invention is comprised of an external housing containing a plurality of air filtration devices, ultraviolet lamps capable of producing high-intensity ultraviolet germicidal irradiation (UVGI) wavelengths, reactors supporting photocatalytic oxidation (PCO), and a modular air movement system that is fully controllable. Each internal component of said invention is individually serviceable and may be easily removed from the invention system for replacement or maintenance.

### BACKGROUND

This invention related to industrial air purification, and specifically to small commercial or office applications in which moderately large volumes of air must be regularly monitored and purified. Although there are many existing systems available to purify the air, most systems rely on air passing through existing heating, ventilation and air conditioning (HVAC) ducting. In many existing air purification systems, ultraviolet light is used to kill airborne organisms. The effectiveness of these systems is largely dependant on the speed at which air is circulated through the cleaning system and the intensity of the ultraviolet light on the air stream. Furthermore, these systems are often expensive and lack portability. In the same manner, these existing air cleaning systems are often large and complicated, thereby requiring a complete shutdown before performing maintenance work.

Insofar as we are aware, there is not an air purification system employing photocatalytic oxidation (PCO) and a series of reactors or device that is fully portable, conveniently designed for compactness and easy maintenance and scaled for industrial, institutional, commercial or residential applications.

### SUMMARY

The invention, an improved and modular air purification system, is constructed of a rigid outer housing that is designed in a manner as to allow the free flow of air from a louvered anterior face to an opposite posterior face. The interior of said housing is designed and constructed as to securely contain a plurality of air filter media used in photocatalytic oxidation (PCO), also referred to as reactor pads, as well as, a plurality of ultraviolet lamps capable of producing intense ultraviolet germicidal irradiation (UVGI) wavelengths. These units, being powered electronically, are capable of eliminating airborne contaminants from passing air. The airflow, controlled by an insert panel containing a plurality of blower sections can be adjusted manually or automatically by the activation or deactivation of one or more blowers. Said insert panel is contained within the invention's outer housing and may be easily removed and replaced without the need for specialized tools or training. The invention will include a large moveable panel located laterally along said housing in order to allow the internal components of the invention to be easily inspected, cleaned, removed, or replaced quickly and efficiently. The invention is also designed to facilitate both field service and field technology upgrades.

### DETAILED DESCRIPTION

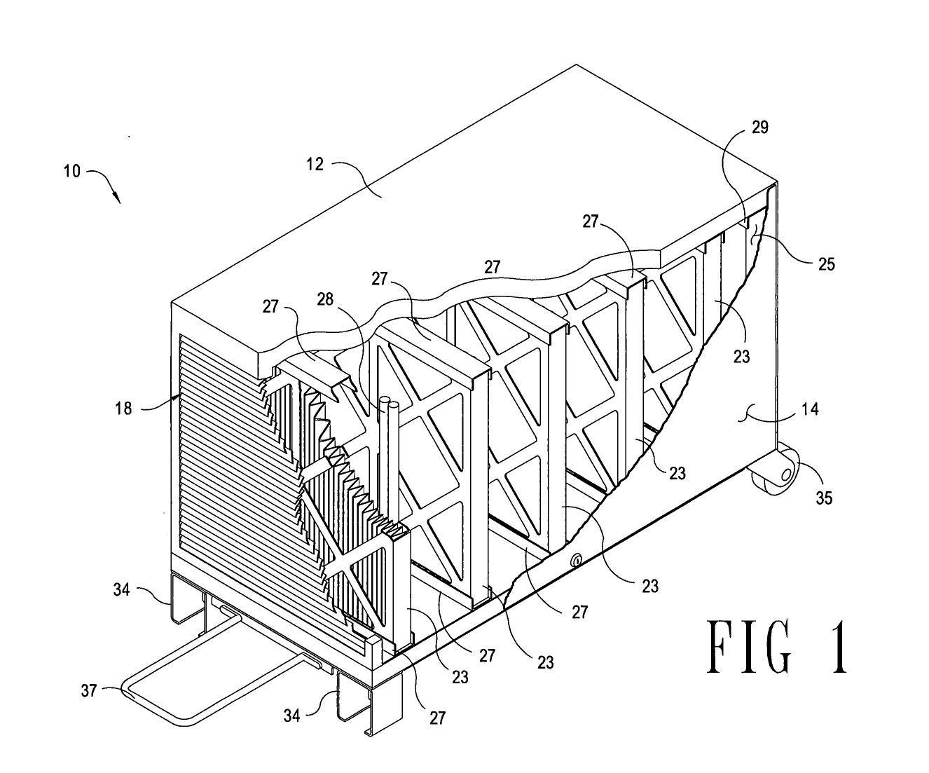

FIG. 1 is a perspective view of the invention with portions removed to illustrate the internal and external components of the invention. FIG. 1 correctly illustrates the preferred embodiment of the invention in which both the anterior and posterior faces of the invention are preceded by a PCO reactor pad.

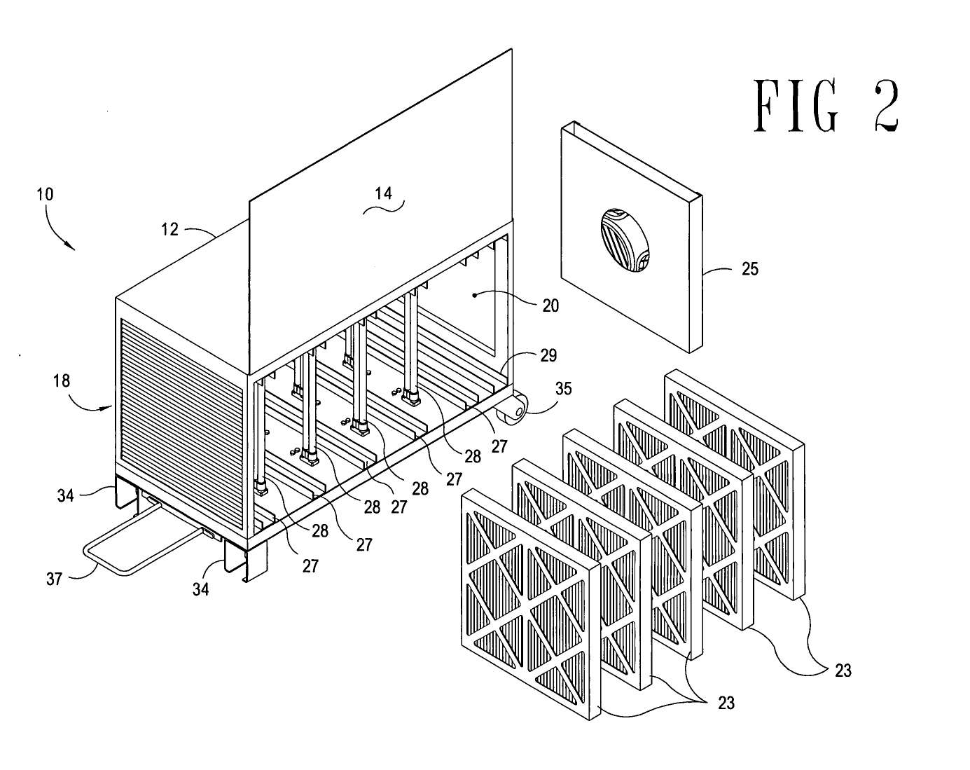

FIG. 2 is an exploded perspective view of the invention and is illustrated with the PCO reactor pads and blower section insert removed. FIG. 2 illustrates the internal design of the invention, specifically the components allowing the secure containment of said PCO reactor pads, removable UVGI lamps, a louvered anterior face, and a posterior face containing an exhaust aperture. FIG. 2 further illustrates a moveable panel located laterally along said invention for the means of inspecting, cleaning or maintaining interior components of the invention.

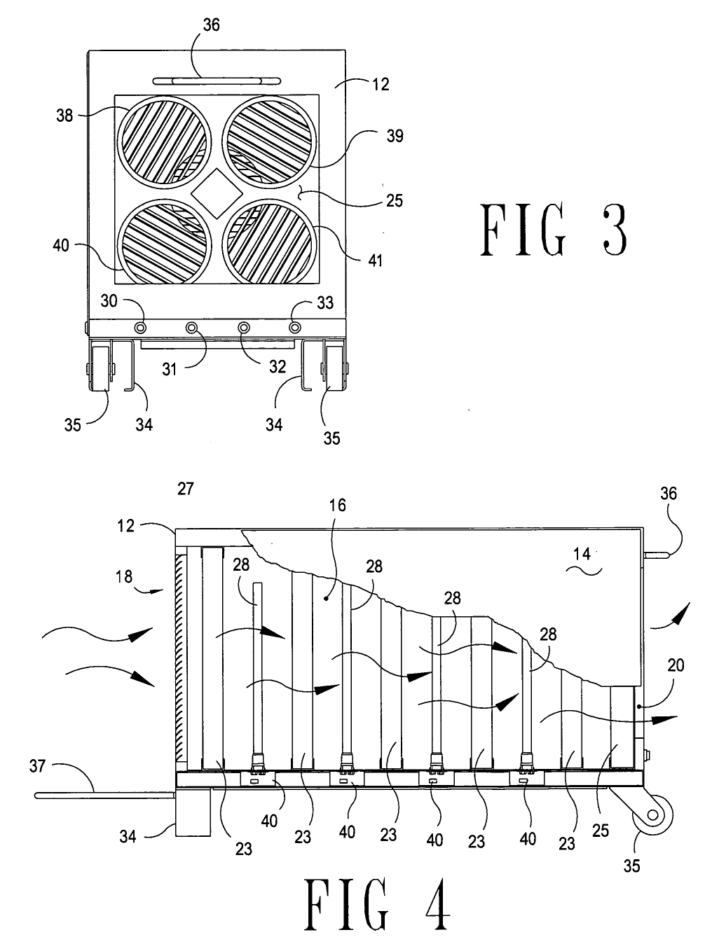

FIG. 3 is a side elevation of the invention and, specifically, an illustration of the posterior end of said invention. FIG. 3 illustrates the posterior face of the housing and the exhaust aperture contained within said posterior face. The posterior face of the invention is illustrated as containing four distinct toggle switches, each of which is individually capable of controlling a single blower fan from an enclosed blower section located immediately against said exhaust aperture. Furthermore, FIG. 3 illustrates a portion of the invention that may be used as a handle for easy transport of the invention or as a support member should the invention be tilted upright.

FIG. 4 is a side elevation of the invention with portions removed to more effectively illustrate the direction and manner in which air will flow through the invention. FIG. 4 illustrates the invention in a horizontal configuration and likewise illustrates the preferred embodiment of the invention, in which the anterior and posterior faces of the housing are preceded by a PCO reactor pad. FIG. 4 also illustrates the correct placement of said PCO reactor pads in relation to a plurality of UVGI lamps. FIG. 4 further illustrates a plurality of electrical components located underneath the air cleaning chamber within said housing, capable of providing and regulating power to said UVGI lamps and a blower section insert. FIG. 4 also illustrates two distinct handles designed into the invention, located at the anterior and posterior faces of the invention.

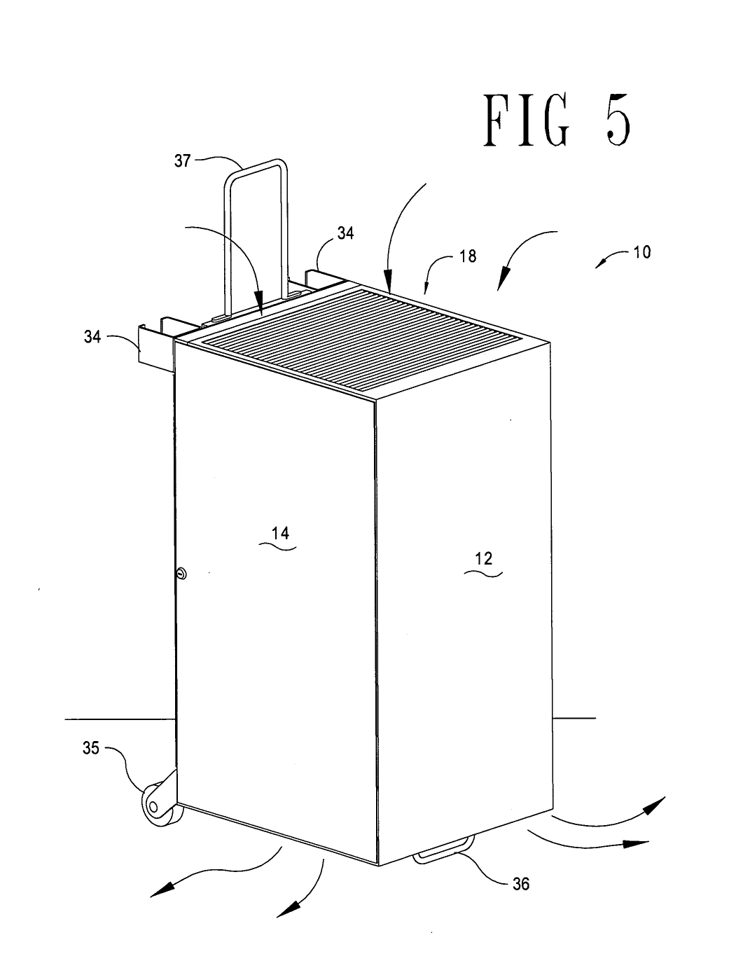

FIG. 5 is a perspective view of the invention in a vertical configuration. FIG. 5 illustrates the versatility of the invention as it is designed in such a manner as to allow it to remain stable and upright in a vertical position. Through the use of the aforementioned posterior handle, the invention is able to maintain a level balance as shown in the FIG. As illustrated in FIG. 5, when used in a vertical configuration, airflow is introduced into the invention from the louvered anterior face, and is pulled in a downward direction, in order to be exhausted from the posterior face of said invention.

Operation

In operation, ambient air is introduced into the invention, generally indicated at 10 in FIG. 1, through a louvered anterior face, indicated at 18. Said louvered face 18 is constructed into a housing 12, which contains a plurality of internal components, including a plurality of PCO reactor pads 23, UGVI lamps 28, and a modular blower section 25. Said internal components are held in place through the use of guide rails 27 and 29 designed for containing the PCO reactor pads and blower section, respectively. The invention is moveable, through the use of a set of casters 35 located about the posterior face of the invention. A set of support members 34 located about the anterior face of the invention allow the invention to remain level when utilized in a horizontal configuration. A lifting handle 37 is similarly included about the anterior face of the invention and is of a design and construction as to be suitable for lifting and transporting the invention.

Said PCO reactor pads 23 and the modular blower system 25 are removable from the invention, as illustrated in FIG. 2. The invention, generally indicated at 10, is illustrated as being comprised of a rigid housing 12 containing four faces. An anterior face, generally indicated at 18 is louvered, while the posterior face of the invention contains an exhaust aperture, indicated at 20, through which the cleaned air will be exhausted from the invention. Said invention is constructed in a manner as to contain a means for the introduction and operation of a plurality of high-intensity UGVI bulbs 28 within said invention and arranged in such a manner as to be alternately installed with said PCO reactor pads 23 as shown in FIG. 4. Access to the interior section of the invention, indicated at 16 is obtained through a moveable cover 14 located laterally along the housing 12 of the invention 10. Said cover 14 also prevents the interior components from shifting laterally by sealing the open lateral face of the housing 12 as shown in FIGS. 1, 2, 4 and 5.

In examining FIG. 3, the relationship and function of the blower section 25 to the invention 10 is made clear. Through the use of a plurality of toggle switches 30, 31, 32 and 33, individual blower fans 38, 39, 40 and 41 may be manually activated or deactivated as determined necessary by the operator. The means of electronically connecting said blower fans to said toggle switches is accomplished through standard and readily available electronic methods.

In operation, the invention 10 is activated, thereby activating a plurality of UVGI bulbs 28. The operator of the invention 10, may then activate a singular or plurality of blower fans 38, 39, 40 and 41 from the blower section 25. Upon activation, said blower fans will create a negative air pressure within the invention, thus forcing ambient air through the louvered front panel 18 and into the air cleaning chamber 16. Untreated air is exposed to high intensity UVGI wavelengths, capable of destroying organic airborne contaminants. A plurality of photoreactive air filtration media (PCO reactor pads) 23 will react with said wavelengths as to create a chemical reaction within said reactor pads 23 in order to create hydroxyradicals (OH radicals) and hydrogen peroxide (H₂O₂). Once created, these OH radicals will react with organic contaminants, degrading and destroying them through oxidation, yielding carbon dioxide and water vapor as by-products. One treated and purified, the air will be exhausted from the invention 10 through the blower section 25 and the posterior exhaust aperture 20. Additionally, OH radicals in the air stream will continue to oxidize organic contaminants throughout the ambient air within the commercial building or residence being treated.

1. A portable linear air purification system, comprising:
an exterior housing that is of rigid construction containing six sides, and
that is capable of containing a plurality of removable internal components,
that contains at least one face containing an aperture of sufficient size and shape for the introduction and removal of internal components,
that contains at least one cover of sufficient size and shape as to seal said aperture,
that contains at least one aperture designated for the introduction of ambient air into the invention,
that contains at least one aperture designated for the exhausting of purified air from the invention,
containing means for the introduction of electrical power to said housing,
containing means for the introduction of an air displacement means within said housing,
containing means for the introduction and operation of a plurality of ultraviolet germicidal irradiation (UVGI) lamps within said housing,
containing means for the introduction and containment of a plurality of photocatalytic oxidation (PCO) reaction pads as air filtration media within said housing,
containing means for the immediate introduction of power and controllability into said air displacement means upon successful insertion within said housing, and
containing means for the immediate removal of power from the array of UVGI lamps and
containing means for the external manual activation and deactivation of one or more portions of said air displacement means,

2. The portable linear air purification system of claim 1, in which the invention comprises a means of facilitating transportation of the invention comprising,
a plurality of casters, mounted upon the housing of the invention,
a plurality of handles, mounted upon the housing of the invention so as to facilitate the lifting and maneuvering of same, and
a plurality of support members, mounted upon the housing as to permit the invention to remain level when in operation.

3. The portable linear air purification system of claim 1, in which the invention comprises a design and construction as to remain fully functional and operational in either a vertical or horizontal position.

4. The portable linear air purification system of claim 1, in which the handles may be utilized as support members.

5. The portable linear air purification system of claim 1, in which said handles and casters may be removable as to allow the introduction of means for hanging or mounting the invention.

6. The portable linear air purification system of claim 1, in which the PCO reactor pad located at the anterior section of the invention may be removed from its primary position and installed into a secondary position within the housing, as to allow the cleaning by photocatalytic oxidation of said reactor pad's anterior face from accumulated airborne contaminants.
